(19) United States
(12) Patent Application Publication
(10) Pub. No.: US 2026/0150009 A1
(43) Pub. Date: May 28, 2026

(54) Methods And Apparatus For Optimal Radio Access Technology Selection-Based Voice Call Fallback In Mobile Communications

(71) Applicant: MediaTek Inc., Hsinchu City (TW)

(72) Inventors: Chin-Te Chen, Hsinchu City (TW); Pan-Yen Chiang, Hsinchu City (TW); Ren-Huang Liu, Hsinchu City (TW)

(73) Assignee: MediaTek Inc., Hsinchu City (TW)

(21) Appl. No.: 19/393,697

(22) Filed: Nov. 19, 2025

Related U.S. Application Data
(60) Provisional application No. 63/725,033, filed on Nov. 26, 2024.

(51) Int. Cl. H04W 36/00; H04W 36/08; H04W 36/30

(52) U.S. Cl. CPC H04W 36/00222; H04W 36/08; H04W 36/304

(57) ABSTRACT

Various solutions for optimal radio access technology (RAT) selection-based voice call fallback in mobile communications are described. The user equipment (UE) may receive a broadcast message from a serving cell. Specifically, the broadcast message is associated with an indication of quality of service (QoS) flow support for Internet protocol (IP) multimedia subsystem (IMS) communication service. Also, the UE may determine whether to initiate an inter-RAT cell or public land mobile network (PLMN) search based on the indication of QoS flow support for IMS communication service. As the voice call fallback can be performed by selecting the optimal RAT, the inefficiency and latency introduced by multiple, sequential fallback attempts can be prevented.

### CROSS REFERENCE TO RELATED PATENT APPLICATION(S)

The present disclosure is part of a non-provisional application claiming the priority benefit of U.S. Patent Application No. 63/725,033, filed 26 Nov. 2024, the content of which herein being incorporated by reference in its entirety.

### TECHNICAL FIELD

The present disclosure is generally related to mobile communications and, more particularly, to optimal radio access technology (RAT) selection-based voice call fallback in mobile communications.

### BACKGROUND

Unless otherwise indicated herein, approaches described in this section are not prior art to the claims listed below and are not admitted as prior art by inclusion in this section.

Voice over New Radio (VoNR) and voice over Long-Term Evolution (VoLTE) are the technology that allows voice calls to be made over the fifth generation (5G) network and the fourth generation (4G) network, respectively. To provide a seamless and high-quality communication experience, the voice service leverages various access technologies and mechanisms to ensure call continuity. These detailed scenarios can be based on call initiation, system fallback, coverage, and quality of service (QoS), along with the associated signaling procedures.

Fallback procedures are necessary when a user equipment (UE) cannot establish a voice or video call on its current network, often because the 5G system lacks Internet protocol (IP) multimedia subsystem (IMS) voice/video support, the UE does not support VoNR, or the 5G signal is weak. When a call starts, the system uses procedures like evolved packet system fallback (EPSFB) to move the service to a stable network, usually 4G LTE. This typically happens because the 5G network rejects the QoS flow setup needed for the voice call.

However, this fallback procedure may add significant latency to call setup. This problem is compounded in the future sixth generation (6G) era due to the integration of triple radio access technologies (RATs), such as 4G, 5G, and 6G. A voice call could require two sequential fallbacks. For example, the voice call initiates on voice over 6G (also referred to as Vo6G). If the 6G network is unable to support the service, the call falls back to VoNR on the 5G system. If the VoNR attempt also fails, the process requires a further transition to VoLTE for call establishment. Each step wastes time and resources because the UE must perform a full cell acquisition, read system information (e.g., master information block (MIB)/system information block (SIB)), set up a new radio resource control (RRC) connection, and perform location registration (LR) twice, drastically delaying the call connection. Accordingly, a more efficient method for voice call fallback is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to optimal radio access technology (RAT) selection-based voice call fallback in mobile communications.

In one aspect, a method may involve an apparatus receiving a broadcast message from a serving cell. Specifically, the broadcast message is associated with an indication of quality of service (QoS) flow support for Internet protocol (IP) multimedia subsystem (IMS) communication service. The method may also involve the apparatus determining whether to initiate an inter-RAT cell or public land mobile network (PLMN) search based on the indication of QoS flow support for IMS communication service.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a broadcast message from a serving cell. Specifically, the broadcast message is associated with an indication of QoS flow support for IMS communication service. The processor, during operation, may also perform operations comprising determining whether to initiate an inter-RAT cell or PLMN search based on the indication of QoS flow support for IMS communication service.

In yet another aspect, a method may involve a network node transmitting a broadcast message to a user equipment (UE). The broadcast message is associated with an indication of QoS flow support for IMS communication service. The method may also involve the network node providing information for an inter-RAT cell or PLMN search to the UE based on the indication of QoS flow support for IMS communication service.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1A is a diagram depicting an example scenario under schemes in accordance with implementations of the present disclosure.

FIG. 1B is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to optimal radio access technology (RAT) selection-based voice call fallback in mobile communications. According to the present disclosure, a number of possible solutions may be implemented separately or jointly. That is, although these possible solutions may be described below separately, two or more of these possible solutions may be implemented in one combination or another.

A mobile-originated (MO) voice call initiated on the fastest RAT, such as a sixth generation (6G) RAT, may fail if the radio access network (RAN) is not properly configured for voice over 6G (Vo6G). In the present disclosure, a direct fallback jump can be achieved by using an indication of quality of service (QoS) flow support for Internet protocol (IP) multimedia subsystem (IMS) communication service associated with a broadcast message. The user equipment (UE) may select an optimal RAT based on the indication rather than making blind attempts.

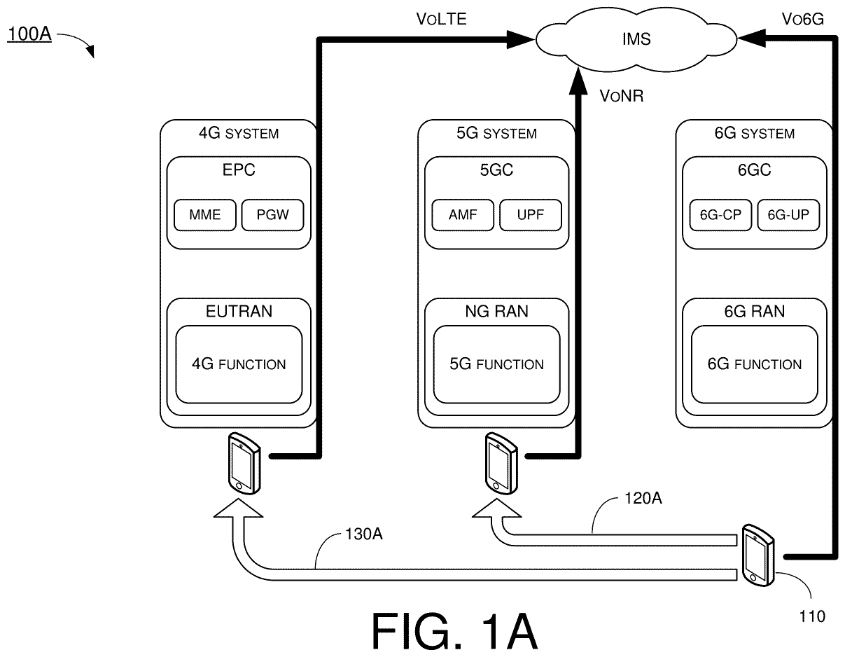

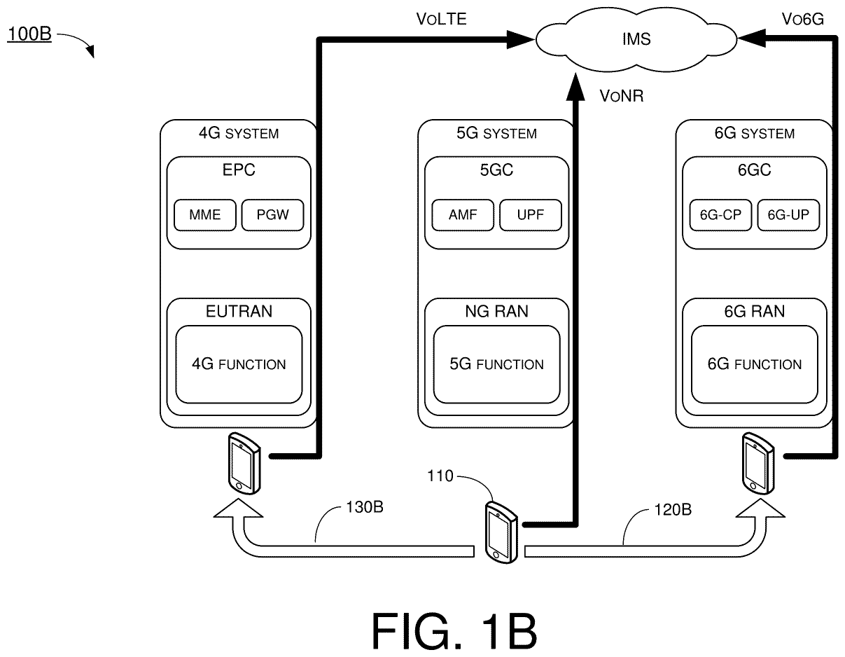

FIG. 1A illustrates an example scenario 100A, in which the UE 110 camps on a cell in a 6G network. The serving cell in a 6G network may broadcast a message associated with an indication of QoS flow support for IMS communication service. The serving cell in the 6G network may also broadcast a reference signal received power (RSRP) threshold of the serving cell itself and an RSRP threshold of at least one neighboring cell in a candidate RAT (e.g., a fifth generation (5G) RAT). The indication and the RSRP threshold information may be broadcast in identical or different messages. After the MO multimedia telephony (MMTEL) service initiation, the UE 110 checks whether the indication is present in the broadcast message. If the indication is present and confirms support of QoS flow for IMS communication service, or if the indication is absent, the UE 110 may evaluate the RSRP threshold of the 6G serving cell. Conversely, if the indication is present and negatively indicates that QoS flow for IMS communication service is not supported, the UE 110 may evaluate the RSRP threshold of the neighboring cell(s) in the 5G RAT.

During the evaluation of the RSRP threshold of the 6G serving cell, the UE 110 transmits a non-access stratum (NAS) service request in the 6G RAT to establish a QoS flow for IMS communication service if a current RSRP is greater than or equal to the RSRP threshold of the 6G serving cell present and supported in the broadcast message, or if the RSRP threshold of the 6G serving cell is absent in the broadcast message. On the other hand, the UE 110 evaluates the RSRP threshold of the neighboring cell(s) in the 5G RAT if the current RSRP is less than the RSRP threshold of the 6G serving cell present and supported in the broadcast message.

During the evaluation of the RSRP threshold of the neighboring cell(s) in the 5G RAT, the UE 110 selects the 5G RAT as a target RAT if a predicted RSRP is greater than or equal to the RSRP threshold of the neighboring cell(s) in the 5G RAT present and supported in the broadcast message. Then, as indicated by the fallback 120A, the UE 110 camps on a cell in the 5G RAT, and transmits the NAS service request or performs a location registration in the 5G RAT to establish the QoS flow for IMS communication service. On the other hand, the UE 110 selects a second RAT (e.g., a fourth generation (4G) RAT) as the target RAT if the predicted RSRP is less than the RSRP threshold of the neighboring cell(s) in the 5G RAT present and supported in the broadcast message, or if the RSRP threshold of the neighboring cell(s) in the 5G RAT is absent in the broadcast message. After that, as indicated by the fallback 130A, the UE 110 camps on a cell in the 4G RAT, and transmits the NAS service request or performs a location registration in the 4G RAT to establish the QoS flow for IMS communication service.

In scenario 100A, the two sequential fallback procedures (e.g., Vo6G to VoNR to VoLTE) are prevented. By utilizing the broadcast indication and RSRP threshold information, the UE can determine the optimal target RAT (either 5G or 4G) and execute a direct fallback jump, bypassing unnecessary intermediate steps.

FIG. 1B illustrates an example scenario 100B, in which the UE 110 camps on a cell in a 5G network. The UE 110 may receive a broadcast message from the 5G serving cell, which is associated with an indication of QoS flow support for IMS communication service. The UE 110 may also receive an RSRP threshold of the 5G serving cell and an RSRP threshold of at least one neighboring cell in a candidate RAT (e.g., a 6G RAT). The indication and the RSRP threshold information may be broadcast in identical or different messages. After the MO MMTEL service initiation, the UE 110 checks whether the indication is present in the broadcast message. The UE evaluates the 5G serving cell RSRP threshold if the QoS flow support is confirmed (i.e., the indication is present and supported, or the indication is absent). In contrast, the UE evaluates the neighboring 6G cell RSRP threshold if the indication is present and explicitly denies QoS flow support for the IMS communication service.

During the evaluation of the RSRP threshold of the 5G serving cell, the UE 110 transmits a NAS service request in the 5G RAT to establish a QoS flow for IMS communication service if a current RSRP is greater than or equal to the RSRP threshold of the serving cell present and supported in the broadcast message, or if the RSRP threshold of the serving cell is absent in the broadcast message. On the other hand, the UE 110 evaluates the RSRP threshold of the neighboring cell(s) in the 6G RAT if the current RSRP is less than the RSRP threshold of the serving cell present and supported in the broadcast message.

During the evaluation of the RSRP threshold of the neighboring cell(s) in the 6G RAT, the UE 110 selects the 6G RAT as a target RAT if a predicted RSRP is greater than or equal to the RSRP threshold of the neighboring cell(s) in the 6G RAT present and supported in the broadcast message. Then, as indicated by the fallback 120B, the UE 110 camps on a cell in the 6G RAT, and transmits the NAS service request or performs a location registration in the 6G RAT to establish the QoS flow for IMS communication service. Alternatively, the UE 110 selects a second RAT (e.g., a 4G RAT) as the target RAT if the predicted RSRP is less than the RSRP threshold of the neighboring cell(s) in the 6G RAT present and supported in the broadcast message, of if the RSRP threshold of the neighboring cell(s) in the 6G RAT is absent in the broadcast message. After that, as indicated by the fallback 130B, the UE 110 camps on a cell in the 4G RAT, and transmits the NAS service request or performs a location registration in the 4G RAT to establish the QoS flow for IMS communication service.

In one embodiment, the indication of QoS flow support for IMS communication service, the RSRP threshold of the serving cell and the RSRP threshold of the neighboring cell(s) in the candidate RAT are carried by one or more system information block (SIB) messages. For example, the SIB in 5G or 6G may have a field IMS-VoiceQoSFlowSupport, indicating whether the cell supports IMS voice/video QoS flow of IMS communication service (real-time transport protocol (RTP), RTP control protocol (RTCP)) for UEs in normal service mode. If the indication is ‘not supported’, the network does not support IMS voice/video calls in the cell for UEs in normal service mode. The 6G SIB may include a field called voiceFallbackNeighborNRThreshold that indicates an RSRP threshold of the neighboring NR cells. The threshold is used to determine whether a fallback procedure is triggered when the signal strength satisfies a specific condition (e.g., the signal strength of the neighbor cell is greater than this threshold). Similarly, the 5G SIB may have a field, voiceFallbackNeighbor6GRThreshold, which indicates the neighboring 6G radio (6GR) RSRP threshold that will trigger a fallback procedure by 6G-RAN.

In one embodiment, 5G/6G SIB may indicate the RSRP threshold of the serving cell. The threshold is used to determine whether a fallback procedure will be triggered if the signal strength meets specific thresholds (e.g., the signal strength of the serving cell is less than this threshold). Specifically, the 6G SIB may include a field, voiceFallback6GRThreshold, indicating the 6GR RSRP threshold that will trigger a fallback procedure by 6G-RAN. The 5G SIB may have a field, voiceFallbackNRThreshold, indicating the NR RSRP threshold that will trigger a fallback procedure by 5G-RAN.

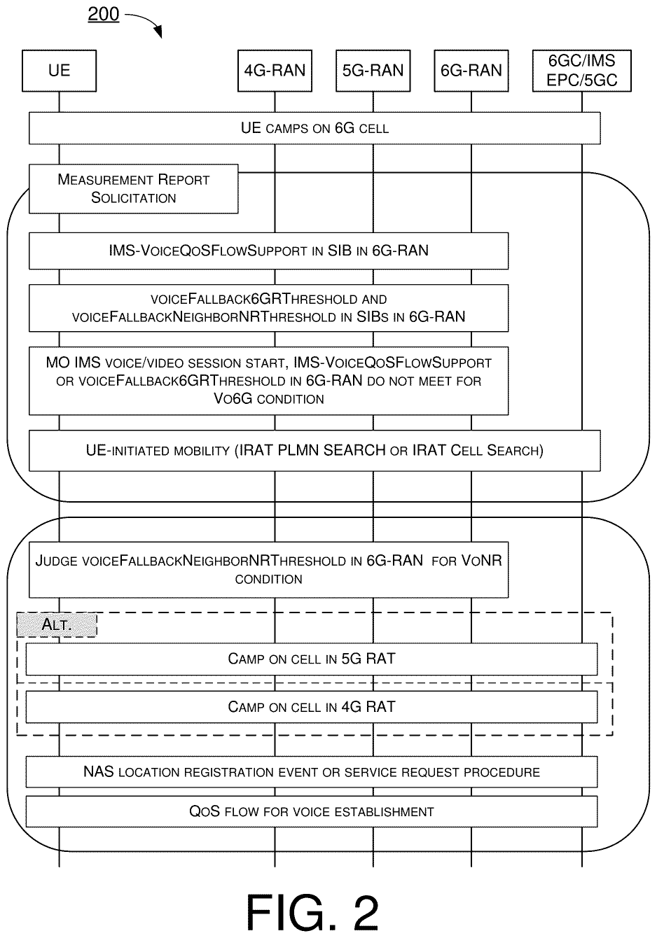

FIG. 2 is a diagram depicting an example scenario 200 under schemes in accordance with implementations of the present disclosure. For the UE camps on a 6G cell, an optimal fallback from 6G to 5G or from 6G to 4G can be achieved. During the initial setup and information acquisition, the UE may be prompted to perform measurement reports, often triggered by the network or its internal criteria (e.g., weak signal or service request). The 6G-RAN broadcasts a SIB containing the IMS-VoiceQoSFlowSupport indication, informing the UE whether the 6G serving cell is capable of supporting the required QoS for IMS voice. The 6G-RAN also broadcasts specific RSRP thresholds via voiceFallback6GRThreshold and voiceFallbackNeighborNRThreshold in SIBs in 6G-RAN. The field voiceFallback6GRThreshold comprises a threshold used to evaluate the current 6G serving cell's signal strength. The field voiceFallbackNeighborNRThreshold comprises a threshold used to evaluate the signal strength of neighboring 5G cells.

When the UE initiates an MO voice call, the voice fallback procedure is immediately triggered if either of two critical conditions is met: the broadcast IMS-VoiceQoSFlowSupport indicator confirms that the current 6G cell cannot provide the necessary QoS flow for Vo6G, or the signal quality of the serving cell (measured by RSRP) has dropped below the configured voiceFallback6GRThreshold. Upon this trigger, the UE acts proactively, immediately initiating a search for a more suitable network, which involves either an Inter-RAT (IRAT) cell search (e.g., looking for a better 5G cell) or an IRAT public land mobile network (PLMN) search to ensure service continuity and quality.

Before committing to a full connection, the UE evaluates the signal strength of available 5G neighbors against the broadcast voiceFallbackNeighborNRThreshold. This is a key decision point for the optimal fallback. If the 5G neighbor RSRP meets the threshold, the UE proceeds to the 5G network. The UE selects the 5G network and enters the idle/inactive state (camps on) a suitable 5G cell. On the other hand, if the 5G neighbor RSRP does NOT meet the threshold, the UE bypasses the 5G network. More specifically, the UE skips 5G and directly selects and camps on a 4G LTE cell. Once the UE has camped on the target RAT (either 5G or 4G), it initiates the connection process by sending a NAS service request message (to resume service) or a location registration message (to update its location). The core network (6GC/IMS/EPC/5GC) and the new RAN complete the signaling to establish the necessary dedicated QoS flow to carry the voice service, successfully completing the voice call initiation.

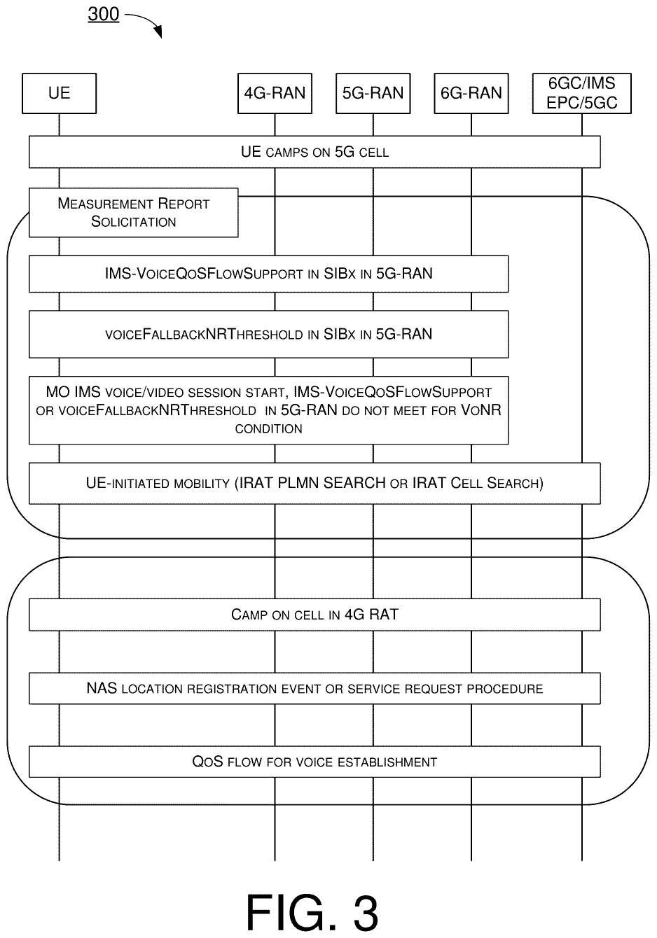

FIG. 3 is a diagram depicting an example scenario 300 for a poor radio condition of the serving cell. In scenario 300, the UE camps on a 5G cell. The UE may perform measurement reports on surrounding cells. The 5G-RAN broadcasts a SIB containing the IMS-VoiceQoSFlowSupport indicator. This informs the UE whether the current cell is capable of providing the required QoS for IMS voice (VoNR). The 5G-RAN also broadcasts the voiceFallbackNRThreshold (RSRP threshold) in its SIBs. This threshold is used by the UE to evaluate the serving 5G cell's signal strength for VoNR condition checking. The fallback procedure may be triggered when the UE attempts a MO call and one of two conditions signals potential failure: the IMS-VoiceQoSFlowSupport indicator shows the 5G cell does not support the required VoNR QoS flow, or the serving cell's signal strength (RSRP) is below the voiceFallbackNRThreshold. Based on the failure trigger, the UE proactively begins searching for a more reliable network. This involves either an IRAT cell search (e.g., looking for a 4G cell) or an IRAT PLMN search. The UE successfully finds a suitable 4G LTE cell and camps on it, entering the idle/inactive state in the 4G RAT. After that, the UE initiates the connection process by sending a NAS location registration message or a service request message to the core network. The core network and the 4G-RAN complete the necessary signaling to establish the dedicated QoS flow required for the voice service (VoLTE), successfully establishing the call.

In the present disclosure, the UE receives multiple parameters via the SIB from the network node. Crucially, the SIB provides an explicit indication of IMS voice/video service support in normal mode and confirms whether the cell can handle the necessary QoS flow for IMS communication. To manage weak coverage, the network provides two distinct RSRP thresholds: one for the serving cell to define the first weak coverage condition, and a separate one for neighboring cells to define a second condition. The UE leverages these indicators to select the most reliable target RAT. By checking the available support indication and comparing the signal strengths against the two thresholds, the UE can determine the optimal target RAT. Finally, the UE camps on a cell in the selected target RAT and sends the NAS location registration or service request message to quickly establish the QoS flow for the voice or video service. The present disclosure offers a significant advantage by replacing reactive, sequential fallback failures with a proactive selection process. By providing the UE with all necessary thresholds and support indicators upfront, the procedure minimizes call setup latency and eliminates unnecessary sequential fallback attempts. This drastically improves the user experience for voice call initiation.

### Illustrative Implementations

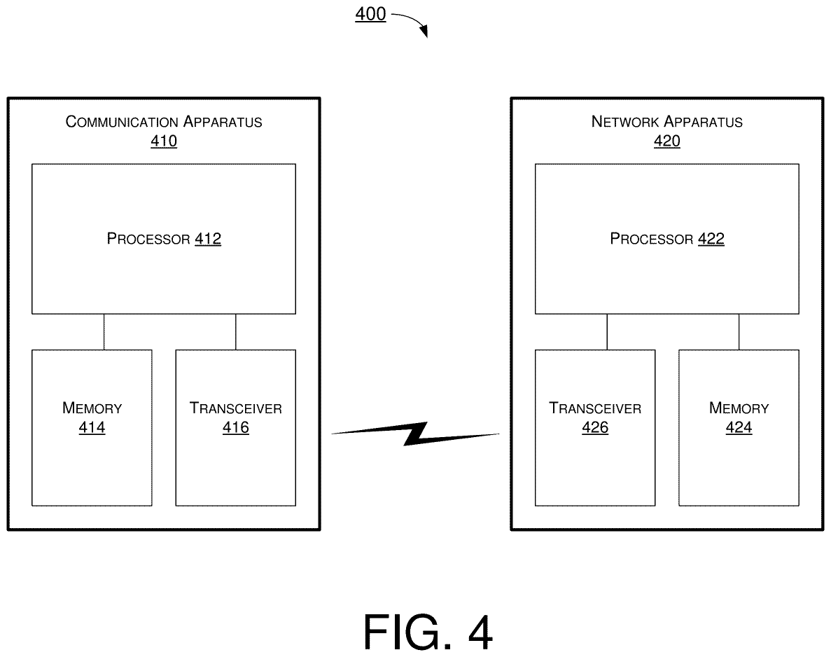

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to optimal RAT selection-based voice call fallback in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus, or a computing apparatus. For instance, communication apparatus 410 may be implemented in a smartphone, a smartwatch, a personal digital assistant, a digital camera, or a computing equipment such as a tablet computer, a laptop computer, or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router a gateway, or other network element. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including optimal RAT selection-based voice call fallback in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

### Illustrative Processes

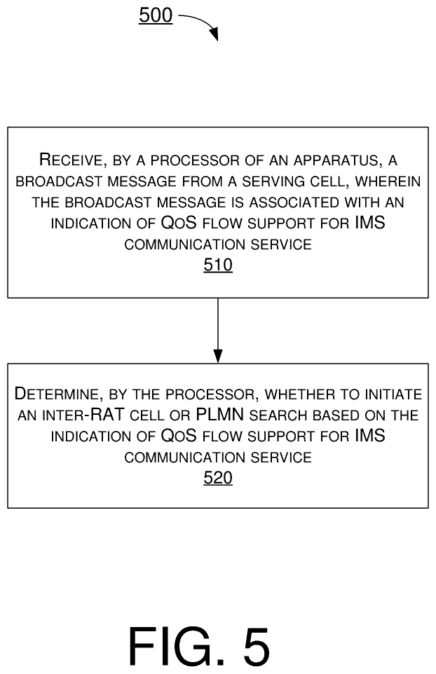

FIG. 5 illustrates an example process 500 in accordance with an implementation of the present disclosure. Process 500 may be an example implementation of above scenarios/schemes, whether partially or completely, with respect to optimal RAT selection-based voice call fallback of the present disclosure. Process 500 may represent an aspect of implementation of features of communication apparatus 410. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 receiving, via transceiver 416, a broadcast message from a serving cell. Specifically, the broadcast message is associated with an indication of QoS flow support for IMS communication service. Process 500 may proceed from block 510 to block 520.

At block 520, process 500 may involve processor 412 of communication apparatus 410 determining whether to initiate an inter-RAT cell or PLMN search based on the indication of QoS flow support for IMS communication service.

In some implementations, process 500 may further involve processor 412 of communication apparatus 410 receiving, via transceiver 416, at least one of an RSRP threshold of the serving cell and an RSRP threshold of at least one neighboring cell in a candidate RAT.

In some implementations, process 500 may further involve processor 412 of communication apparatus 410 evaluating the RSRP threshold of the serving cell in an event that the indication of QoS flow support for IMS communication service is present and supported or absent in the broadcast message. Furthermore, process 500 may involve processor 412 of communication apparatus 410 evaluating the RSRP threshold of the at least one neighboring cell in an event that the indication of QoS flow support for IMS communication service is present and not supported.

In some implementations, process 500 may involve processor 412 of communication apparatus 410 transmitting, via transceiver 416, a NAS service request in a current RAT to establish a QoS flow for IMS communication service in an event that the RSRP threshold of the serving cell is present and supported in the broadcast message and a current RSRP is greater than or equal to the RSRP threshold of the serving cell. Furthermore, process 500 may involve processor 412 of communication apparatus 410 evaluating the RSRP threshold of the at least one neighboring cell in an event that the RSRP threshold of the serving cell is present and supported in the broadcast message and the current RSRP is less than the RSRP threshold of the serving cell. Furthermore, process 500 may involve processor 412 of communication apparatus 410 transmitting, via transceiver 416, the NAS service request in a current RAT to establish the QoS flow for IMS communication service in an event that the RSRP threshold of the serving cell is absent in the broadcast message.

In some implementations, process 500 may involve processor 412 of communication apparatus 410 selecting the candidate RAT as a target RAT in an event that the RSRP threshold of the at least one neighboring cell is present and supported in the broadcast message and a predicted RSRP is greater than or equal to the RSRP threshold of the at least one neighboring cell. Process 500 may also involve processor 412 of communication apparatus 410 selecting a second RAT as the target RAT in an event that the RSRP threshold of the at least one neighboring cell is present and supported in the broadcast message and the predicted RSRP is less than the RSRP threshold of the at least one neighboring cell. Process 500 may also involve processor 412 of communication apparatus 410 selecting a 4G RAT as the target RAT in an event that the RSRP threshold of the at least one neighboring cell is absent in the broadcast message. Process 500 may also involve processor 412 of communication apparatus 410 camping on a cell in the target RAT. Further, process 500 may involve processor 412 of communication apparatus 410 transmitting, via transceiver 416, the NAS service request or performing a location registration in the target RAT to establish the QoS flow for IMS communication service.

In some implementations, the candidate RAT is a 5G RAT and the second RAT is a 4G RAT in an event that the current RAT is a 6G RAT.

In some implementations, the candidate RAT is a 6G RAT and the second RAT is a 4G RAT in an event that the current RAT is a 5G RAT.

In some implementations, the indication of QoS flow support for IMS communication service, the RSRP threshold of the serving cell and the RSRP threshold of the at least one neighboring cell are carried by identical or different broadcast messages.

In some implementations, each broadcast message comprises a SIB message.

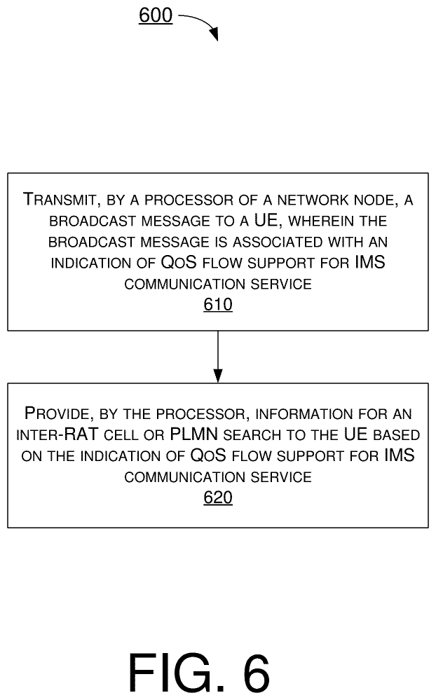

FIG. 6 illustrates an example process 600 in accordance with an implementation of the present disclosure. Process 600 may be an example implementation of above scenarios/schemes, whether partially or completely, with respect to optimal RAT selection-based voice call fallback in mobile communications. Process 600 may represent an aspect of implementation of features of network apparatus 420. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any base stations or network nodes. Solely for illustrative purposes and without limitation, process 600 is described below in the context of network apparatus 420. Process 600 may begin at block 610.

At block 610, process 600 may involve processor 422 of network apparatus 420 transmitting, via transceiver 426, a broadcast message to a UE (e.g., communication apparatus 410). More specifically, the broadcast message is associated with an indication of QoS flow support for IMS communication service. Process 600 may proceed from block 610 to block 620.

At block 620, process 600 may involve processor 422 of network apparatus 420 providing information for an inter-RAT cell or PLMN search to the UE based on the indication of QoS flow support for IMS communication service.

In some implementations, process 600 may also involve processor 422 of network apparatus 420 transmitting, via transceiver 426, at least one of an RSRP threshold of the serving cell and an RSRP threshold of at least one neighboring cell in a candidate RAT to the UE.

In some implementations, the indication of QoS flow support for IMS communication service, the RSRP threshold of the serving cell and the RSRP threshold of the at least one neighboring cell are carried by identical or different SIB messages.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a broadcast message from a serving cell, wherein the broadcast message is associated with an indication of quality of service (QoS) flow support for Internet protocol (IP) multimedia subsystem (IMS) communication service; and
determining, by the processor, whether to initiate an inter-radio access technology (RAT) cell or public land mobile network (PLMN) search based on the indication of QoS flow support for IMS communication service.

2. The method of claim 1, further comprising:
receiving, by the processor, at least one of a reference signal received power (RSRP) threshold of the serving cell and an RSRP threshold of at least one neighboring cell in a candidate RAT.

3. The method of claim 2, wherein the determining of whether to initiate the inter-RAT cell or PLMN search based on the indication of QoS flow support for IMS communication service further comprises:
evaluating the RSRP threshold of the serving cell in an event that the indication of QoS flow support for IMS communication service is present and supported or absent in the broadcast message; and
evaluating the RSRP threshold of the at least one neighboring cell in an event that the indication of QoS flow support for IMS communication service is present and not supported.

4. The method of claim 3, wherein the evaluating of the RSRP threshold of the serving cell further comprises:
transmitting a non-access stratum (NAS) service request in a current RAT to establish a QoS flow for IMS communication service in an event that the RSRP threshold of the serving cell is present and supported in the broadcast message and a current RSRP is greater than or equal to the RSRP threshold of the serving cell;
evaluating the RSRP threshold of the at least one neighboring cell in an event that the RSRP threshold of the serving cell is present and supported in the broadcast message and the current RSRP is less than the RSRP threshold of the serving cell; and
transmitting the NAS service request in a current RAT to establish the QoS flow for IMS communication service in an event that the RSRP threshold of the serving cell is absent in the broadcast message.

5. The method of claim 4, wherein the evaluating of the RSRP threshold of the at least one neighboring cell further comprises:
selecting the candidate RAT as a target RAT in an event that the RSRP threshold of the at least one neighboring cell is present and supported in the broadcast message and a predicted RSRP is greater than or equal to the RSRP threshold of the at least one neighboring cell;
selecting a second RAT as the target RAT in an event that the RSRP threshold of the at least one neighboring cell is present and supported in the broadcast message and the predicted RSRP is less than the RSRP threshold of the at least one neighboring cell;
selecting a fourth generation (4G) RAT as the target RAT in an event that the RSRP threshold of the at least one neighboring cell is absent in the broadcast message;
camping on a cell in the target RAT; and
transmitting the NAS service request or performing a location registration in the target RAT to establish the QoS flow for IMS communication service.

6. The method of claim 5, wherein the candidate RAT is a fifth generation (5G) RAT and the second RAT is a fourth generation (4G) RAT in an event that the current RAT is a sixth generation (6G) RAT.

7. The method of claim 5, wherein the candidate RAT is a sixth generation (6G) RAT and the second RAT is a fourth generation (4G) RAT in an event that the current RAT is a fifth generation (5G) RAT.

8. The method of claim 2, wherein the indication of QoS flow support for IMS communication service, the RSRP threshold of the serving cell and the RSRP threshold of the at least one neighboring cell are carried by identical or different broadcast messages.

9. The method of claim 8, wherein each broadcast message comprises a system information block (SIB) message.

10. An apparatus, comprising:
a transceiver which, during operation, communicates wirelessly; and
a processor communicatively coupled to the transceiver such that, during operation, the processor performs operations comprising:
receiving, via the transceiver, a broadcast message from a serving cell, wherein the broadcast message is associated with an indication of quality of service (QoS) flow support for Internet protocol (IP) multimedia subsystem (IMS) communication service; and
determining whether to initiate an inter-radio access technology (RAT) cell or public land mobile network (PLMN) search based on the indication of QoS flow support for IMS communication service.

11. The apparatus of claim 10, wherein during operation, the processor further performs operations comprising:
receiving, via the transceiver, at least one of a reference signal received power (RSRP) threshold of the serving cell and an RSRP threshold of at least one neighboring cell in a candidate RAT.

12. The apparatus of claim 11, wherein during operation, the processor further performs operations comprising:
evaluating the RSRP threshold of the serving cell in an event that the indication of QoS flow support for IMS communication service is present and supported or absent in the broadcast message; and
evaluating the RSRP threshold of the at least one neighboring cell in an event that the indication of QoS flow support for IMS communication service is present and not supported.

13. The apparatus of claim 12, wherein during operation, the processor further performs operations comprising:
transmitting, via the transceiver, a non-access stratum (NAS) service request in a current RAT to establish a QoS flow for IMS communication service in an event that the RSRP threshold of the serving cell is present and supported in the broadcast message and a current RSRP is greater than or equal to the RSRP threshold of the serving cell;
evaluating the RSRP threshold of the at least one neighboring cell in an event that the RSRP threshold of the serving cell is present and supported in the broadcast message and the current RSRP is less than the RSRP threshold of the serving cell; and
transmitting the NAS service request in a current RAT to establish the QoS flow for IMS communication service in an event that the RSRP threshold of the serving cell is absent in the broadcast message.

14. The apparatus of claim 13, wherein during operation, the processor further performs operations comprising:
selecting the candidate RAT as a target RAT in an event that the RSRP threshold of the at least one neighboring cell is present and supported in the broadcast message and a predicted RSRP is greater than or equal to the RSRP threshold of the at least one neighboring cell;
selecting a second RAT as the target RAT in an event that the RSRP threshold of the at least one neighboring cell is present and supported in the broadcast message and the predicted RSRP is less than the RSRP threshold of the at least one neighboring cell;
selecting a fourth generation (4G) RAT as the target RAT in an event that the RSRP threshold of the at least one neighboring cell is absent in the broadcast message;
camping on a cell in the target RAT; and
transmitting, via the transceiver, the NAS service request or performing a location registration in the target RAT to establish the QoS flow for IMS communication service.

15. The apparatus of claim 14, wherein:
the candidate RAT is a fifth generation (5G) RAT and the second RAT is a fourth generation (4G) in an event that the current RAT is a sixth generation (6G) RAT; or
the candidate RAT is the 6G RAT and the second RAT is the 4G RAT in an event that the current RAT is the 5G RAT.

16. The apparatus of claim 11, wherein the indication of QoS flow support for IMS communication service, the RSRP threshold of the serving cell and the RSRP threshold of the at least one neighboring cell are carried by identical or different broadcast messages.

17. The apparatus of claim 16, wherein each broadcast message comprises a system information block (SIB) message.

18. A method, comprising:
transmitting, by a processor of a network node, a broadcast message to a user equipment (UE), wherein the broadcast message is associated with an indication of quality of service (QoS) flow support for Internet protocol (IP) multimedia subsystem (IMS) communication service; and
providing, by the processor, information for an inter-radio access technology (RAT) cell or public land mobile network (PLMN) search to the UE based on the indication of QoS flow support for IMS communication service.

19. The method of claim 18, further comprising.
transmitting, by the processor, at least one of a reference signal received power (RSRP) threshold of the serving cell and an RSRP threshold of at least one neighboring cell in a candidate RAT to the UE.

20. The method of claim 19, wherein the indication of QoS flow support for IMS communication service, the RSRP threshold of the serving cell and the RSRP threshold of the at least one neighboring cell are carried by identical or different system information block (SIB) messages.
